(19) United States
(12) Patent Application Publication
(10) Pub. No.: US 2008/0113193 A1
(43) Pub. Date: May 15, 2008

(54) Method of Moulding a Part in a Hydraulically-Setting Matrix and Part Thus Produced

(75) Inventor: Pablo Ignacio Comino Almenara, Madrid (ES)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT GOBAIN VETROTEX FRANCE, CHAMBERY (FR)

(21) Appl. No.: 10/574,504

(22) PCT Filed: Oct. 1, 2004
(86) PCT No.: PCT/FR04/50479

§ 371 Date: Nov. 30, 2007

(30) Foreign Application Priority Data
Oct. 3, 2003 (ES) P200302301

(51) Int. Cl. B29C 39/42

(52) U.S. Cl. 428/361; 264/101

(57) ABSTRACT

A process for manufacturing an article by molding and the article obtained by the process. The process includes an injection molding in a mold, a vacuum water extraction, and a demolding the fresh article.

The aim of the present patent application is to propose a process for manufacturing an article, made of a hydraulically-setting matrix, by molding and an article obtained by this process.

At the present time, glass-fiber-reinforced cement (GRC) panels are widely used for the covering of walls instead of conventional concrete panels, in order to take advantage of their high mechanical performance, with smaller thicknesses and therefore greater lightness. In addition to their use for cladding (wall cladding panels and architectural elements), they lend themselves to other applications, such as for sanitaryware (shower trays and ancillary components), and also interior components. Likewise, because of their high fire resistance, they are often used in other types of construction requiring this characteristic, such as for example ovens used for cooking food, such as bread, pizzas, etc. They may also be employed for the manufacture of transport pallets instead of wood, which is the material generally used for this purpose.

However, the current process for manufacturing these articles is lengthy and expensive, since the molding and demolding are carried out entirely by hand and, in particular, since the drying time before demolding is not less than 24 hours.

The first object of the invention is to alleviate these drawbacks by proposing an effective process for manufacturing an article made of a hydraulically-setting matrix by molding.

For this purpose, the invention proposes a process for manufacturing an article, made of a hydraulically-setting matrix, by molding comprising the following steps:

a) injection of a slurry containing a hydraulic binder and mixing water into a mold;

b) vacuum extraction of the mixing water; and

c) demolding of the fresh article.

The process according to the invention is more compatible with industrial requirements than the processes of the prior art, in which the demolding takes place dry. This is because the vacuum extraction considerably reduces the mold occupation time. This process therefore makes it possible to reduce the amount of material used and also the time devoted to the manufacture of the articles.

Furthermore, the process according to the invention is simple to implement and can be easily automated.

A first step of the process according to the present invention may consist in mixing the slurry. To do this, the components of the slurry are introduced, for example, into a mixer fitted with a stirring system, and stirring is continued until a homogeneous mixture is obtained. The occluded air produced during mixing can be removed inside the pressure tank.

Next, the slurry may be transferred to a tank fitted for example with suitable locking systems that allow the inside to be pressurized. The tank may incorporate an internal system for removing bubbles, this being based on a vacuum process, optionally accompanied by generating vibrations from the outside, if necessary, so that the occluded air is not introduced into the mold with the injected slurry.

Next, the slurry is injected into the mold, preferably by pressurizing the abovementioned tank.

Preferably, the injection may take place at low pressure or at high pressure. The operating pressure for low-pressure injection is preferably between 1.5 and 4 bar, while the high pressure is preferably between 4 and 30 bar, depending on the case and taking into account this pressure in the design of the mold.

This injection operation may also be carried out by any other conventional means, such as a peristaltic pump or compressed air (in the case of low-pressure injection).

The vacuum is preferably produced by a vacuum pump.

The excess water is extracted so that the article has the desired moisture content. Advantageously the final water content represents a compromise, allowing problem-free handling of the article while preventing any cracking through lack of water. In addition the water/cement ratio after the vacuum extraction step may preferably be between 0.25 and 0.5.

Advantageously, the duration of the vacuum extraction step of the process according to the present invention is less than 1 hour. This makes it possible in particular to significantly increase the efficiency compared with existing processes.

Likewise, the process allows articles to be obtained, for example, for floors, that have, for example, a thickness of between 0.2 cm and 5 cm without impairing either their physical or their mechanical properties. This helps to reduce the amount of material used, making it possible to reduce costs and to obtain lighter articles, thereby making it easier to handle them and lay them.

To obtain the final article, the manufacturing process according to the invention may comprise the hardening of the article obtained. To significantly reduce risks of microcracks and deformations liable to result in the article obtained being scrapped, the hardening preferably takes place under humidity and temperature conditions allowing the article to resume the necessary hydration levels after the loss of water undergone during the vacuum extraction step. Also advantageously, the relative humidity during the hardening may be between 90% and 100%, and the total hardening time may be between 1 and 7 days.

Optionally, other hardening systems, such as steam, an autoclave, etc., may be selected.

In a preferred embodiment, chopped reinforcement fibers are mixed into the slurry before the injection and/or reinforcement fibers are placed in the mold before injection.

In one advantageous method of implementation, a support element is placed in the mold before injection and the fresh article laid on said support is removed by means of said support.

Moreover, this support may be a metal part and may also have the shape desired for the article, for example in order to manufacture a panel with rounded regions in the form of tiles.

According to one feature, the vacuum extraction may start during slurry injection.

Furthermore, the injection and/or extraction may be carried out via one face and/or both faces of a closed molding system comprising a mold and a countermold. For example, it is possible to extract the water via the upper face (of the countermold) and to turn the mold upside down in order to extract via the lower face (of the mold).

The injection and/or extraction may be carried out via one or more orifices, which may or may not be different, these being provided in the mold and/or the countermold.

Moreover, the injection and/or extraction may be distributed over part or all of the lower and/or upper surface of the molding system.

Furthermore, it is possible to manufacture an article that includes one or more metal inserts for the final fastening of the article (cladding panels, etc.) for example to a structure, by placing these inserts in the mold before injection of the slurry.

Furthermore, the mold may optionally be heated in order to accelerate the setting process.

A mold for implementing the process according to the invention may consist of a closed mold system (mold/countermold) and may include at least one inlet orifice via which the slurry, preferably homogenized beforehand, is injected and at least one second orifice, which may or may not be different from the first, for said extraction.

To prevent the system from failing, it is possible to include, in the mold, one or more slurry outlet orifices or overflows, which are themselves fitted with locking mechanisms that allow them to be closed in order to prevent a pressure drop during vacuum water extraction.

To allow vacuum water extraction, the mold is also preferably provided with a plurality of orifices with a diameter not exceeding 1 cm, which are connected, directly or indirectly, to the vacuum extraction system. Likewise, to avoid loss of material during this vacuum step, a filter paper or any other conventional filtration system may be placed between said orifices and the slurry. During this step, the mold may optionally be heated in order to speed up the setting process.

If a support element is placed in the mold, the latter may preferably include one or more orifices facing the mold or the countermold.

If the extraction and the injection are carried out via the countermold, it is then possible to provide an element, for example a magnetic element, in contact with the countermold and provided with orifices facing those of the countermold.

The subject of the present invention is also an article, made of a hydraulically-setting matrix, obtained by the process described above. Its composition comprises a weight percent of hydraulic binder between 2% and 98% of the total mass, a weight percent of sand between 0.1% and 95% of the total mass, a weight percent of water between 5% and 75% of the total mass, a weight percent of reinforcement fibers between 0% and 50% of the total mass (preferably glass fibers, and between 2.5% and 7%), a weight percent of other fibers between 0% and 50% of the total mass, a weight percent of polymers between 0% and 75% of the total mass, a weight percent of superplasticizer between 0% and 20% of the total mass, a weight percent of metakaolin between 0% and 50% of the total mass and optionally other additives selected so as to give the article the required characteristics.

Because of its composition, this article has a high temperature resistance. The composition also makes it possible to improve its mechanical properties and to lighten conventional concrete articles.

Said articles may be used for covering walls and structures requiring a high level of fire resistance.

The process according to the invention relates not only to the injection molding and manufacture of cement-based components (cement being used as hydraulic binder), and envisions not only these components, but it also envisions the possibility of using other hydraulic binders, such as gypsum, plaster, lime and calcium silicate.

It is also possible to mix several binders. The matrix may furthermore consist of a cement mixed with other aggregates, gypsums, plasters, lime, synthetic resins, polymers, plastics of various typologies, thermoplastics, etc.

When the binder comprises a cement, the cement used may preferably be a quick-setting cement with a high initial strength, a conventional Portland cement of whatever strength, aluminous cement, a low-alkali cement and in general any type of cement whatsoever, the choice of which must be taken into account when designing the article, so as always to maintain its hydraulic binder characteristic.

The polymers may, for example, be of the acrylic or synthetic type, resins of various typologies or any other polymer that can be used to modify the matrix and give the manufactured article a greater capacity in terms of various design and performance aspects that are expected of the article. Optionally, the polymers are to be added only when the final GRC article is not intended for high-temperature applications and will be used only as wall panels and cladding, or in other applications not requiring particular fire resistance or high-temperature resistance.

Moreover, the other additives may be inter alia accelerators, retarders, emulsifiers, air entrainers, occluded air agents, stabilizers, antioxidants, plasticizers, or thickeners, such as cellulose, cellulose fibers, cellulose hydroxides of any type, and other chemical thickeners, also starches or natural products that can be used to improve the cohesion and stability of the injected slurry, and in general any additive for the purpose of modifying the matrix according to the design and performance requirements expected of the article, and also possible production requirements.

The reinforcement fibers may be chopped fibers, whole fibers, a mat of whatever class of chopped reinforcement fibers, a mat of continuous fibers, such as Cem-FIL® sold by Saint-Gobain, or woven meshes.

Likewise, the reinforcement fibers may be synthetic fibers, such as polyamide, rayon, nylon, PVA and polypropylene fibers, and, in general, any organic fiber, natural fiber (such as coconut fiber, treated plant-based fiber, cellulose fiber or sisal fiber) or synthetic fiber of whatever class; mineral fibers, such as carbon fiber, basalt fiber and, in general, any mineral fiber of whatever class; glass fiber, of the E, Z, C or AR (alkali resistant) glass fiber type and, in general, any glass fiber of any composition; metal fibers, such as copper, steel, stainless steel, iron, cast iron and ductile cast iron fibers and, in general, any fiber of metal type. Mention may also be made of graphite, boron, ceramic or basalt fibers.

The other fibers may be insulation fibers for example from rock wool or glass wool.

Table 1 below gives a few examples of compositions for the articles for example made of GRC according to the present invention, for comparison with articles made of conventional GRC.

TABLE 1

| | Cement | Sand | Water | | Super- | |
|---|---|---|---|---|---|---|
| | (kg) | (kg) | (kg) | Polymer | plasticizer | Metakaolin |
| Conventional GRC | 50 | 33 | 16 | 3-7% (by | 0-1% (by | 0-50% (by |
| Conventional GRC | 50 | 33 | 16.5 | weight) of the | weight) of the | weight) of the |
| Conventional GRC | 50 | 50 | 17.5 | cement of | cement | cement |
| Conventional GRC | 50 | 33 | 16 | polymer | | |
| Conventional GRC | 50 | 50 | 13 | solids | | |
| Conventional GRC | 50 | 50 | 14.5 | | | |
| Conventional GRC | 50 | 33 | 17.5 | | | |
| Injection-molded | 50 | 40 | 22.5 | | | |
| GRC according to | | | | | | |
| the invention | | | | | | |
| Injection-molded | 50 | 40 | 40 | | | |
| GRC according to | | | | | | |
| the invention | | | | | | |
| Injection-molded | 50 | 40 | 30 | | | |
| GRC according to | | | | | | |
| the invention | | | | | | |
| Injection-molded | 50 | 40 | 21 | | | |
| GRC according to | | | | | | |
| the invention | | | | | | |

In the combination, the proportions of the various types of fiber are adjusted so as to achieve good performance in the application and to obtain the various mechanical strength levels. The combination of the various types of fiber is designed for adjustment compatible with the other components of the matrix, so as to allow injection of the mixture without major problems. The materials constituting the reinforcement (fibers) may be used in any other proportion according to the advantages or performance characteristics that it is desired to obtain with the injection-molded article.

For example, we use AR glass fibers having a length of 12 mm and in proportion between 2 and 3%.

A preferred embodiment is described below; however, it should be noted that this does not restrict the invention.

After having weighed the materials, they are mixed according to the following procedure: the cement and the sand are progressively added to the required amount of water, obtaining a sand/cement ratio of 0.8 and a water/cement ratio of 0.45. Mixing is continued until a homogeneous mixture is obtained. The chopped reinforcement fibers (for example glass fibers) and the additives are added, mixing then continuing until a homogeneous slurry is obtained.

To do this, the components of the slurry are introduced into a mixer fitted with a stirring system, and stirring is continued until a homogeneous mixture is obtained. The occluded air produced during mixing is removed inside a pressure tank.

Next, the slurry is transferred to a tank fitted for example with suitable locking systems that allow the inside to be pressurized. The tank incorporates an internal system for removing bubbles, this being based on a vacuum process, optionally accompanied by generating vibrations from the outside, if necessary, so that the occluded air is not introduced into the mold with the injected slurry.

Next, the mold is prepared for the injection. To prevent the loss of material during the evacuation step, filter paper or any other conventional filtration system may be placed between said orifices and the slurry. For example, a filter paper or special films may be placed above a lower support or sleeve placed on the mold and designed to allow the fresh article to be easily removed. Furthermore, a woven reinforcement mesh, for example made of glass fiber, of suitable shape is preferably placed in the mold.

The mold consists, for example, of a closed-mold system (mold/countermold) and includes, for example, nine orifices on the mold and the countermold, preferably distributed uniformly and facing them, via which orifices the homogenized slurry is injected and/or the extraction is carried out.

To prevent the system from failing, provision may be made to include, in the mold, one or more slurry outlet orifices or overflows, which are themselves fitted with locking mechanisms that allow them to be closed in order to prevent a pressure drop during vacuum water extraction.

The tank is filled via the orifices with the slurry obtained beforehand, and then closed and pressurized. After having obtained a pressure of 2.5-3 bar, the valves for outputting the slurry from the tank are opened so that the material flows into the mold.

When the overflows indicate that the mold is full, the vacuum source is turned on and the injection stopped. To allow vacuum water extraction, one or more of the orifices have a diameter not exceeding 1 cm and are connected, directly or indirectly, to the vacuum extraction system.

The total pressurization time is 15 minutes, which produces a final water/cement ratio that varies between 0.35 and 0.40. During this step, the mold may optimally be heated in order to accelerate the setting process.

Next, the mold is opened, the article is removed from the mold and this article is inserted into the hardening chamber in order to obtain the required level of hydration and hardening of the article. The hardening takes place at room temperature and at a relative humidity of greater than 95% for 7 days.

1-19. (canceled)

20. A process for manufacturing an article, made of a hydraulically-setting matrix, by molding, comprising:
a) injection of a slurry containing a hydraulic binder and mixing water into a mold;
b) vacuum extraction of the mixing water; and
c) demolding of the fresh article.

21. The process for manufacturing an article by molding as claimed in claim 20, wherein the injection of the slurry into the mold takes place by pressurizing an injection tank.

22. The process for manufacturing an article by molding as claimed in claim 20, wherein the injection of the slurry into the mold takes place by a peristaltic pump.

23. The process for manufacturing an article by molding as claimed in claim 20, wherein the injection of the slurry into the mold takes place by compressed air.

24. The process for manufacturing an article by molding as claimed in claim 20, wherein the injection takes place at a pressure between 1.5 and 4 bar.

25. The process for manufacturing an article by molding as claimed in claim 20, wherein the injection takes place at a pressure between 4 and 30 bar.

26. The process for manufacturing an article by molding as claimed in claim 20, wherein a water/cement ratio after the vacuum extraction step is between 0.25 and 0.5.

27. The process for manufacturing an article by molding as claimed in claim 20, allowing articles to be produced with a thicknesses between 0.2 and 5 cm.

28. The process for manufacturing an article by molding as claimed in claim 20, wherein a duration of the vacuum extraction step is less than 1 hour.

29. The process for manufacturing an article by molding as claimed in claim 20, further comprising hardening the article that takes place under relative humidity conditions between 90% and 100%.

30. The process for manufacturing an article by molding as claimed in claim 29, wherein a total duration of the hardening is between 1 and 7 days.

31. The process for manufacturing an article by molding as claimed in claim 29, wherein the hardening takes place in a presence of steam.

32. The process for manufacturing an article by molding as claimed in claim 29, wherein the hardening takes place in an autoclave.

33. An article made of a hydraulically-setting matrix, obtained using the process of claim 20, wherein the article comprises a weight percent of hydraulic binder between 2% and 98% of the total mass, a weight percent of sand between 0.1% and 95% of the total mass, a weight percent of water between 5% and 75% of the total mass, a weight percent of reinforcement fibers between 0% and 50% of the total mass, a weight percent of other fibers between 0% and 50% of the total mass, a weight percent of polymers between 0% and 75% of the total mass, a weight percent of superplasticizer between 0% and 20% of the total mass, and a weight percent of metakaolin between 0% and 50% of the total mass.

34. The article made of a hydraulically-setting matrix as claimed in claim 33, wherein the hydraulic binder comprises a cement, the cement may be a quick-setting cement with a high initial strength, a conventional Portland cement of any strength, aluminous cement, a low-alkali cement and in general any type of cement whatsoever, the choice of which must be taken into account when designing the article, so as always to maintain its hydraulic binder characteristic.

35. The article made of a hydraulically-setting matrix as claimed in claim 33, wherein the polymers may be of acrylic or synthetic type, resins of various typologies or any other polymer that can be used to modify the matrix and give the manufactured article a greater capacity in terms of various design and performance aspects that are expected of the article.

36. The article made of a hydraulically-setting matrix as claimed in claim 33, further comprising other additives which may be accelerators, retarders, emulsifiers, air entrainers, occluded air agents, stabilizers, antioxidants, plasticizers, or thickeners, such as cellulose, cellulose fibers, cellulose hydroxides of any type, and other chemical thickeners, also starches or natural products that can be used to improve the cohesion and stability of the injected slurry, and in general any additive for the purpose of modifying the matrix according to the design and performance requirements expected of the article, and also possible production requirements.

37. The article made of a hydraulically-setting matrix as claimed in claim 33, wherein the reinforcement fibers may be chopped fibers, whole fibers, a mat of whatever class of chopped reinforcement fibers, a mat of continuous fibers, or woven meshes.

38. The article made of a hydraulically-setting matrix as claimed in claim 33, wherein the reinforcement fibers may be synthetic fibers, such as polyamide, rayon, nylon, PVA and polypropylene fibers, and, in general, any organic or synthetic fiber of whatever class; mineral fibers, such as carbon fiber, basalt fiber and, in general, any mineral fiber of whatever class; glass fiber, such as E-, Z-, C- and AR-glass fiber and, in general, any glass fiber of any composition; metal fibers, such as copper, steel, stainless steel, iron, cast iron and ductile cast iron fibers and, in general, any fiber of metal type.
